(19) United States
(12) Patent Application Publication
(10) Pub. No.: US 2016/0168494 A1
(43) Pub. Date: Jun. 16, 2016

(54) Method for Purifying Synthesis Gases

(71) Applicant: ECOLOOP GMBH, Goslar (DE)

(72) Inventors: Leonhard BAUMANN, Aldersbach (DE); Roland MÖLLER, Bad Harzburg (DE)

(21) Appl. No.: 14/891,090

(22) PCT Filed: May 7, 2014
(86) PCT No.: PCT/EP2014/001223

§ 371 Date: Nov. 13, 2015

(30) Foreign Application Priority Data
May 16, 2013 (DE) 10 2013 008 422.9

(51) Int. Cl. C10K 1/02; B01D 53/00; B01D 46/46; C10K 3/00; B01D 39/20

(52) U.S. Cl. CPC C10K 1/024; C10K 3/008; B01D 39/2068; B01D 46/46; B01D 53/002

(57) ABSTRACT

The method serves for cleaning dust-laden synthesis gases (1) which are formed in reactors or shaft furnaces (2) by carbothermal and/or electrothermal processes and which after departing the reactor or the shaft furnace at elevated temperatures are freed from dusty solids (4) via physical separation techniques (3) and are cooled by means of a downstream heat exchanger (5). In order to achieve a combination of long filter service life with effective synthesis gas cleaning, the proposal is that the dust-laden synthesis gas (1) after departing the reactor (2) and before being freed from dusty solids be passed in the presence of steam via a residence section (6), with the difference between the final gas temperature (T3) of the synthesis gas after it has been freed from the dusty solids and cooled and the maximum gas temperature in the residence section (T2) being set to at least 400 K.

The present invention is concerned with a method for cleaning dust-laden synthesis gases which are formed in reactors or shaft furnaces by carbothermal and/or electrothermal processes and which after departing the reactor or the shaft furnace at elevated temperatures are freed from dusty solids via physical separation techniques and are cooled by means of a downstream heat exchanger.

One such method is known from DE 10 2007 062 414 A1. It has emerged, however, that the hot gas filtration proposed therein is problematic without further measures, since in spite of the subsequent entrained-flow gasification, the gas stream may still include long-chain or aromatic hydrocarbons, which may impair the filter activity or may even block the filter used.

The object of the present invention is to improve the existing method for producing synthesis gas so that long filter service life is achieved while the synthesis gas is nevertheless freed very effectively from dusty contaminants and also from long-chain or aromatic hydrocarbons still present.

In accordance with the invention, the object is achieved in that in a method of the type described at the outset, the dust-laden synthesis gas after departing the reactor and before being freed from dusty solids is passed in the presence of steam via a residence section, with the difference between the final gas temperature (T3) of the synthesis gas after it has been freed from the dusty solids and cooled and the maximum gas temperature in the residence section (T2) being set to at least 400 K.

It has emerged that the residence section upstream of the filter allows the level of long-chain or aromatic hydrocarbon components of the gas stream to be lowered significantly, permitting the use of an effective filter without any risk of the blocking of this filter. As a consequence of the desired deposition of water in the form of condensate, the final temperature of the synthesis gas is less than 100° C., for example, 50° C. Correspondingly, the maximum gas temperature in the residence section is well above 400° C., for example, between 450° C. and 750° C.

The dimensioning of the residence section is of course critically dependent on the volumes for which the plant in which the above-described method is implemented is dimensioned. As a preferred order of magnitude, a ratio may be stated which is formed by the amount of synthesis gas formed per hour, in standard cubic meters, and the volume of the residence section, in m³, of not more than 10000.

At its most simple, the residence section may be configured in the form of a correspondingly dimensioned pipeline, which in order to achieve suitable residence times may also have a helical design, for example, or which in order to achieve a corresponding volume may also be extended in the manner of a kettle.

Residence times which have proven particularly useful for the synthesis gas in the residence section are between 0.5 and 15 seconds; the residence time is preferably between 1.5 and 10 seconds and more preferably between 2 and 8 seconds. The residence time set represents a tradeoff between the desire for maximally complete reaction of the unwanted components and the desire for a high throughput; this purpose may be served, as mentioned, by corresponding structural design of the residence section.

In the residence section, preferably, at least two mechanical blocking devices are arranged serially, with the gas space between the blocking devices being charged at least intermittently with an inert gas as barrier medium.

This measure may be necessary for safety purposes, in order to prevent the possible formation of an explosive mixture in the filter installations downstream of the residence section.

Thus, for example, in one preferred development of the method, the oxygen content of the synthesis gas can be measured intermittently and/or continuously at at least one location in the residence section and one safety measure may preferably involve the oxygen content measured in the residence section serving as a monitoring variable and on reaching an upper limit automatically triggering the closing of the serially arranged mechanical blocking devices in the residence section, thereby preventing the formation of an explosive gas mixture in downstream filter housings.

The freeing from the dusty solids is accomplished preferably by filtration via temperature-stable ceramic filter elements, installed in one or more filter housings, at temperatures of above 300° C.

In addition to the aforementioned temperature difference of 400 K, these temperatures prevent any components possibly still present in the filter elements from condensing out and blocking the filter cross sections.

For the dimensioning of the filter housings, a ratio formed by the amount of synthesis gas formed per hour, in standard cubic meters, and the volume of all the filter housings, in cubic meters, of not more than 20 has proven advantageous.

In one preferred development of the method, provision is made for the synthesis gas to be cooled by indirect cooling by means of a liquid cooling medium in one or more shell-and-tube heat exchangers, with the resulting final synthesis gas temperature (T3) being below the aforementioned 100° C. and the condensates formed in this process being removed at least partly from the gas phase.

Condensates obtained in the cooling of the synthesis gas, with an intrinsic temperature of below 100° C., are preferably metered at least partly into the synthesis gas stream before the synthesis gas is cooled additionally by indirect cooling in the gas cooler. This has the positive effect that unwanted deposits on the inside of the cooler can be reduced.

The dedusted and cooled synthesis gas is conveyed preferably by means of a gas conveying device arranged after the gas cooler which draws off the synthesis gas under suction from the reactor or the shaft furnace, and so a pressure gradient is developed across the residence section, the filter housings, and the gas cooler, with the difference between the pressure of the synthesis gas at the start of the residence section and the pressure of the synthesis gas after the gas cooler being at least 50 mbar, in order to ensure the desired gas throughput.

As already mentioned, the reactor or shaft furnace may comprise a countercurrent gasifier with moving bed of bulk material which is supplied with carbon-containing materials for the purpose of gasification and additionally with oxygen-containing gas in substoichiometric amount as gasifying medium, the total A in the reactor being preferably less than 0.5 and more preferably less than 0.4.

Lastly, in a still-further preferred embodiment of the method, provision is made for alkaline substances to be added to the dust-laden synthesis gas before entry into the residence section and/or directly in the residence section. It has emerged that the thermal cracking can be promoted substantially by utilization of catalytic effects, with alkaline substances used preferably comprising carbonates or hydroxides or oxides of the alkali metals or alkaline earth metals, or mixtures of these substances.

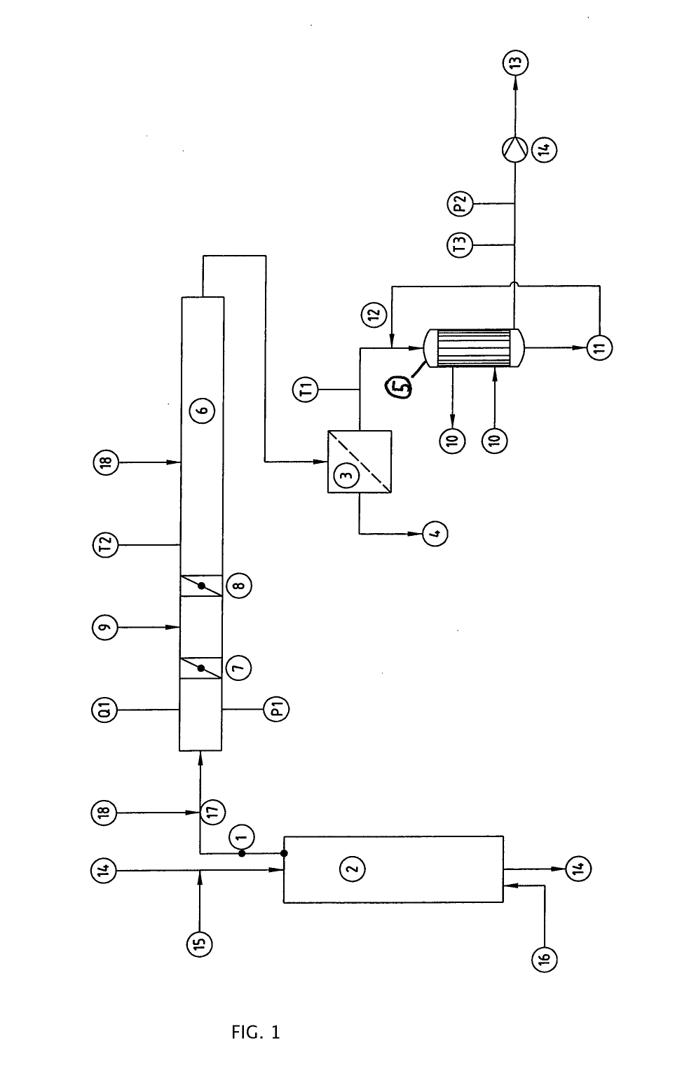

FIG. 1 shows, and is intended to elucidate, but not restrict—one advantageous configuration of the method.

Crude synthesis gas (1), formed for example in a gasifying reactor (2), may comprise not only entrained dust but also long-chain or aromatic hydrocarbons, depending on the conditions of its formation in the reactor. In order to be able to free the crude synthesis gas from the entrained dust (4) efficiently by gas filtration (3), it is advantageous to use thermal and/or chemical cracking to reduce such components, usually unwanted, in the gas stream. Preferably, therefore, the synthesis gas (1) is heated to a gas temperature (T2) of, for example, 600° C. and is passed in the presence of steam via a residence section (6) in order thereby to achieve thermal/chemical cracking of these gas components.

The gas can be filtered by means, for example, of filtration via ceramic filter elements (3), it being advantageous if the gas temperature (T1) after the filtration step is at least 300° C. Depending on the use of the synthesis gas, it is usually appropriate for the dust-free synthesis gas to be cooled in a gas cooler (5), which is designed as a shell-and-tube heat exchanger, for example. This shell-and-tube heat exchanger is typically subjected to cooling water (10) on the outside of the tubes. The condensates (11) deposited in this procedure may consist of different liquid phases.

It has proven advantageous for the cooling effect for the condensates to be at least partly admixed again with the hot synthesis gas at (12) before and/or during entry into the gas cooler at (5) and in this way to make a contribution to reducing unwanted deposits on the inside of the cooler as well. The dedusted and cooled synthesis gas (13) is conveyed via a gas conveying device (14), with a pressure gradient being developed across gas filtration and the gas cooler, and the synthesis gas being drawn under suction through these devices. The final gas temperature (T3) is less than 100° C., and so the steam is condensed out.

One particularly preferred procedure may be achieved by the use as gasifying reactor (2) of a countercurrent gasifier which is traversed by a top-to-bottom flow of a moving bed (14) of bulk material, this bed being admixed, prior to entry into the reactor, with carbon-rich substances (15). In order to develop an efficient countercurrent principle in the reactor, oxygen-containing gas (16) is metered in at the bottom end of the reactor. With regard to the control of the amount of gas, the procedure is preferably such that substoichiometric conditions are established in the reactor, with the total lambda being less than 0.5 and preferably less than 0.4.

In order to accelerate the reduction in long-chain or aromatic hydrocarbons present in the dust-laden synthesis gas (1), alkaline substances (18) may be admixed to the synthesis gas before entry into the residence section (17), or else directly into the residence section (6). By this means, the thermal cracking can be promoted substantially by exploitation of catalytic effects.

1. A method for cleaning dust-laden synthesis gases (1) which are formed in reactors or shaft furnaces (2) by carbothermal and/or electrothermal processes and which after departing the reactor or the shaft furnace at elevated temperatures are freed from dusty solids (4) via physical separation techniques (3), and are cooled by means of a downstream heat exchanger (5), characterized in that the dust-laden synthesis gas (1) after departing the reactor (2) and before being freed from dusty solids is passed in the presence of steam via a residence section (6), with the difference between the final gas temperature (T3) of the synthesis gas after it has been freed from the dusty solids and cooled and the maximum gas temperature in the residence section (T2) being set to at least 400 K.

2. The method as claimed in claim 1, characterized in that the ratio formed by the amount of synthesis gas (1) formed per hour, in standard cubic meters, and the volume of the residence section (6), in cubic meters, is not more than 10000.

3. The method as claimed in either of the preceding claims, characterized in that the residence section (6) is configured in the form of a pipeline.

4. The method as claimed in any of the preceding claims, characterized in that in the residence section at least two mechanical blocking devices (7 and 8) are arranged serially and the gas space between the blocking devices is charged at least intermittently with an inert gas (9) as barrier medium.

5. The method as claimed in any of the preceding claims, characterized in that the freeing from the dusty solids is accomplished by filtration (3) via temperature-stable ceramic filter elements, installed in one or more filter housings, at temperatures above 300 degrees Celsius.

6. The method as claimed in any of the preceding claims, characterized in that the ratio formed by the amount of synthesis gas (1) formed per hour, in standard cubic meters, and the volume of all the filter housings (3), in cubic meters, is not more than 20.

7. The method as claimed in any of the preceding claims, characterized in that the synthesis gas is cooled by indirect cooling by means of a liquid cooling medium (10) in one or more shell-and-tube heat exchangers (5), with the resulting synthesis gas temperature (T3) being below 100 degrees Celsius and the condensates (11) formed in this process being removed at least partly from the gas phase.

8. The method as claimed in claim 7, characterized in that the condensates obtained in the cooling of the synthesis gas, with an intrinsic temperature of below 100 degrees Celsius, are metered at least partly directly into the synthesis gas stream at (12) before the synthesis gas is cooled additionally by indirect cooling in the gas cooler (5).

9. The method as claimed in any of the preceding claims, characterized in that the oxygen content (Q1) of the synthesis gas is measured intermittently and/or continuously at at least one location in the residence section (6).

10. The method as claimed in claim 9, characterized in that the oxygen content (Q1) measured in the residence section (6) serves as a monitoring variable and on reaching an upper limit it automatically triggers the closing of the serially arranged mechanical blocking devices (7 and 8) in the residence section (6) and thereby prevents the formation of an explosive gas mixture in the downstream filter housings (3).

11. The method as claimed in any of the preceding claims, characterized in that the dedusted and cooled synthesis gas (13) is drawn off under suction from the reactor or the shaft furnace (2), by means of a gas conveying device (14) arranged after the gas cooler, and consequently a pressure gradient is developed across the residence section (6), the filter housings (3), and the gas cooler (5), with the difference between the pressure of the synthesis gas at the start of the residence section (P1) and the pressure of the synthesis gas after the gas cooler (P2) being at least −50 mbar.

12. The method as claimed in any of the preceding claims, characterized in that the reactor or shaft furnace (2) comprises a countercurrent gasifier with moving bed (14) of bulk material which is supplied with carbon-containing materials (15) for the purpose of gasification and additionally with oxygen-containing gas (16) in substoichiometric amount as gasifying medium.

13. The method as claimed in claim 12, characterized in that the total lambda in the reactor is less than 0.5 and preferably less than 0.4.

14. The method as claimed in any of the preceding claims, characterized in that alkaline substances (18) are added to the dust-laden synthesis gas (1) before entry into the residence section (6) at (17) and/or directly into the residence section (6).

15. The method as claimed in claim 14, characterized in that alkaline substances (18) used are carbonates, oxides or hydroxides of the alkali metals or alkaline earth metals, or mixtures of these substances.

16. The method as claimed in any of the preceding claims, characterized in that the residence time of the synthesis gas in the residence section (6) is set between 0.5 and 15 seconds.

17. The method as claimed in claim 16, characterized in that the residence time of the synthesis gas in the residence section (6) is set between 1.5 and 10 seconds, preferably between 2 and 8 seconds.
